(19) United States
(12) Patent Application Publication
(10) Pub. No.: US 2011/0023840 A1
(43) Pub. Date: Feb. 3, 2011

(54) Exhaust Gas Cooler

(75) Inventors: Luis Carlos Cattani, Aurora, IL (US); Paul Gottemoller, Palos Park, IL (US); Peter Popadiuc, Bensenville, IL (US); Robert L. Rowells, Elmwood Park, IL (US); Bashar Y. Melhem, Orland Park, IL (US); Martin R. Zielke, Lockport, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/533,410

(22) Filed: Jul. 31, 2009

(51) Int. Cl. F02M 25/07

(52) U.S. Cl. 123/568.12

(57) ABSTRACT

A method of cooling exhaust gas (F) from an engine in an EGR cooler (10) for recirculation to the engine includes the steps of transporting the exhaust gas from the engine to a core assembly (22) disposed inside a single housing assembly (20), and dividing the housing assembly into at least a first cooling volume (42) of the EGR cooler (10) and a second cooling volume (44) of the EGR cooler (10). The core assembly (22) extends at least partially into the first cooling volume (42) and the second cooling volume (44). The method also includes the steps of introducing a first cooling fluid (CF1) into the first cooling volume (42), and introducing a second cooling fluid (CF2) into the second cooling volume (44). The exhaust gas (F) is transported from the core assembly (22) to the engine.

### BACKGROUND

Embodiments described herein relate generally to exhaust gas recirculation (EGR) systems in vehicles. More specifically, embodiments described herein relate to coolers used in EGR systems in vehicles.

Exhaust gas recirculation (EGR) is used to reduce nitrogen oxide (NOx) emissions in both gasoline and diesel engines. NOx is primarily formed when a mix of nitrogen and oxygen is subjected to high temperatures. EGR systems recirculate a portion of an engine's exhaust gas back to the engine cylinders. Intermixing fresh, incoming air with recirculated exhaust gas dilutes the mix, which lowers the flame temperature and reduces the amount of excess oxygen. The exhaust gas also increases the specific heat capacity of the mix, which lowers the peak combustion temperature. Since NOx is more readily formed at high temperatures, the EGR system limits the generation of NOx by keeping the temperatures low.

Most EGR systems include one or more EGR coolers either mounted to the engine or in fluid communication between an exhaust manifold and an intake manifold of an engine. Some engines, especially compression ignition or diesel engines, use the EGR cooler to cool the portion of exhaust gas being recirculated. The cooled exhaust gas has a lower latent heat content and can aid in lowering combustion temperatures even further. In general, engines using EGR to lower their NOx emissions can attain lower emissions by cooling the recirculated exhaust gas as much as possible.

Some EGR systems have two EGR coolers, known as dual EGR coolers. The two EGR coolers have separate housings that are mounted in series in a spaced arrangement. The first EGR cooler reduces the temperature of the exhaust gas, and the second EGR cooler further reduces the temperature of the exhaust gas. Between the two EGR coolers there are typically funnel-shaped diffusers at the entrances and exits to the EGR coolers to direct the exhaust gas from the first EGR cooler to the second EGR cooler

### SUMMARY OF THE INVENTION

A method of cooling exhaust gas from an engine in an EGR cooler for recirculation to the engine includes the steps of transporting the exhaust gas from the engine to a core assembly disposed inside a single housing assembly, and dividing the housing assembly into at least a first cooling volume and a second cooling volume. The core assembly extends at least partially into the first cooling volume and the second cooling volume. The method also includes the steps of introducing a first cooling fluid into the first cooling volume, and introducing a second cooling fluid into the second cooling volume. The exhaust gas is transported from the core assembly to the engine.

### BRIEF DESCRIPTION OF THE DRAWINGS

FIG. 1 is a schematic section-view of a dual-stage EGR cooler having a single housing assembly.

### DETAILED DESCRIPTION

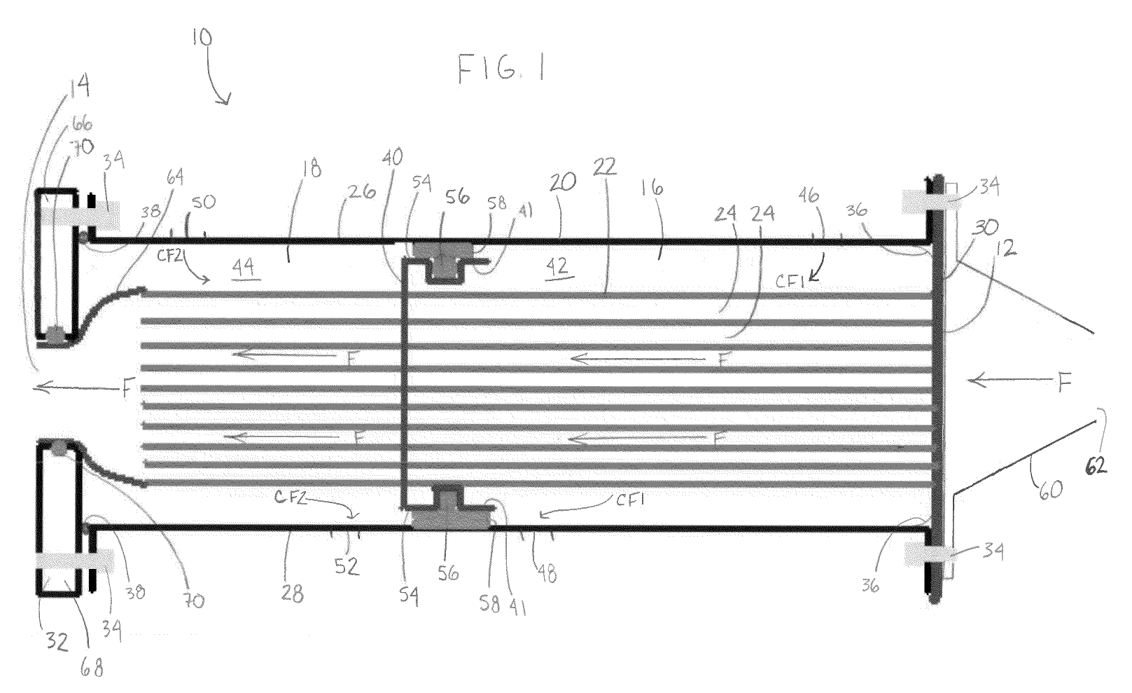

Referring now to FIG. 1, an EGR cooler is indicated generally at 10 and is configured to be incorporated in an EGR system (not shown) at the exhaust manifold (not shown) or in fluid communication between the exhaust manifold and an intake manifold (not shown) of an engine (not shown). The EGR cooler 10 receives a flow of exhaust gases F, such as from the exhaust manifold, at an inlet 12 of the EGR cooler and in the direction indicated in FIG. 1. The exhaust gases flow through the EGR cooler 10 to an outlet 14.

Between the inlet 12 and the outlet 14, the exhaust gases are cooled in the EGR cooler 10 by a cooling fluid CF, for example engine coolant, as will be discussed in greater detail below. The exhaust gases may be cooled from about 1100-degrees Fahrenheit to about 300-degrees Fahrenheit, although other temperatures are contemplated. In the EGR cooler 10, the exhaust gases are cooled in two stages, a first stage or higher-temperature stage, and a second stage or lower-temperature stage. In the direction of exhaust gas flow F, the exhaust gases are first cooled at the higher-temperature stage followed by the lower-temperature stage.

A first or high-temperature radiator 16 of the EGR cooler 10 forms the first stage, and is upstream of a second or low-temperature radiator 18 of the EGR cooler 10 that forms the second stage. It is possible that additional radiators may be incorporated into the EGR cooler 10. The first or high-temperature radiator 16 and the second or low-temperature radiator 18 are housed in a single housing assembly 20. Locating both the first or high-temperature radiator 16 and the second or low-temperature radiator 18 in the same housing assembly 20 reduces potential flow restrictions of the exhaust gas F, as compared to the conventional dual EGR cooler configuration where individual cooler housings are provided in series. Further, the single housing assembly 20 may be lighter and less costly than providing two or more individual cooler housings.

The EGR cooler 10 has a core assembly 22 that extends into both the first or high-temperature radiator 16 and the second or low-temperature radiator 18. The flow of exhaust gas F is within the core assembly 22, which extends generally from the inlet 12 to the outlet 14. Alternatively, the core assembly 22 may extend substantially the distance between the inlet 12 and the outlet 14.

The core assembly 22 is generally elongate and has a rectangular shape in transverse cross-section, however other shapes are possible. The core assembly 22 includes a plurality of tube-and-fin assemblies 24 that provide fluid communication of the exhaust gas flow F through the core assembly 22. The tube-and-fin assemblies 24 may be formed of stainless steel, or any other highly corrosion-resistant material. It is possible that the tube-and-fin assemblies 24 may have a spaced arrangement to permit the cooling fluid CF to flow in the spaces between the tube-and-fin assemblies 24.

The housing assembly 20 is generally elongate and rectangular in transverse cross-section, and has first and second side members 26, 28 that are generally parallel with the core assembly 22. Third and fourth side members (not shown) are generally similar to first and second side members 26, 28 but are generally disposed perpendicularly to the first and second side members to form the generally rectangular shape of the housing assembly 20.

End caps 30, 32 are generally perpendicular to the core assembly 22. To form the housing assembly 20, the side members 26, 28 are attached to the end caps 30, 32 with fasteners 34. A first seal 36 is provided at the attachment of the end cap 30 to the side members 26, 28, and a second seal 38 is provided at the attachment of the end cap 32 to the side members 26, 28. It is possible that the housing assembly 20 can have a configuration other than generally rectangular.

A collar 40 is disposed generally transverse to the core assembly 22, and separates the first or high-temperature radiator 16 from the second or low-temperature radiator 18. The collar 40 may be brazed or otherwise sealingly attached to the core assembly 22, and sealed to the housing assembly 20 to form a first cooling fluid volume 42 and a second cooling fluid volume 44. A first radiator inlet 46 to the first cooling fluid volume 42 is disposed on a first side member 26, and a first radiator outlet 48 is disposed on a second side member 28. A second radiator inlet 50 of the second cooling volume 44 is disposed on a first side member 26, and a second radiator outlet 52 is disposed on a second side member 28. The cooling fluid CF can either have a parallel flow or a counterflow arrangement.

The collar 40 is mounted within the housing assembly 20 with a seal mount 54, which is attached to the side members 26, 28. The seal mount 54 includes a seal 56, such as an O-ring, and mount members 58 attached to an interior surface of the side members 26, 28. The seal 56 is located between the mount member 58 and the collar 40. The collar 40 may have an extension portion 41 that engages the mount member 58. In this configuration, the core 22 does not contact the side members 26, 28 of the housing assembly 20, but has a “floating” configuration. Alternatively, the collar 40 may be brazed to the interior surface of the housing assembly 20.

Exhaust gas F flows through the inlet 12 of the core assembly 22, which is an opening located at the end cap 30. An entrance diffuser 60 may be attached to the inlet 12 of the core assembly 22. The entrance diffuser 60 may be located at the exterior, the interior or partially to the interior/exterior of the housing assembly 20. The entrance diffuser 60 may have a diffuser inlet 62 that receives the flow of exhaust gas F. The exhaust gas F flows through diffuser inlet 62, through the entrance diffuser 60, through the inlet 12 and through the core assembly 22. An outlet diffuser 64 fluidly connects the core assembly 22 to the outlet 14.

The end cap 32 may have a two-piece assembly, for example having a first adapter 66 and a second adaptor 68, which therebetween receives the outlet diffuser 64. The adapters 66, 68 maintain the core assembly 22 in the floating configuration within the housing assembly 20. A seal 70, such as an O-ring, seals the cooling fluid CF within the second cooling fluid volume 44.

The cooling fluid CF1 flows through the first or high-temperature radiator 16 between the housing assembly 20 and the core assembly 22, and in the case where the tube-and-fin assemblies 24 have a spaced relationship, between the tube-and-fin assemblies. The collar 40 seals the flow of cooling fluid CF within the first or high-temperature radiator 16. At the first radiator inlet 46 of the first or high-temperature radiator 16, the cooling fluid is about 220-degrees Fahrenheit, however other temperatures are contemplated.

Cooling fluid CF2 flows though the second or low-temperature radiator 18 between the housing assembly 20 and the core assembly 22, and in the case where the tube-and-fin assemblies 24 have a spaced relationship, between the tube-and-fin assemblies. The collar 40 seals the flow of cooling fluid CF within the second or low-temperature radiator 18. At the second radiator inlet 50 of the second or low-temperature radiator 18, the cooling fluid is about 110-degrees Fahrenheit, however other temperatures are contemplated. The second cooling fluid CF2 has a lower temperature than the first cooling fluid CF1.

It is possible that the collar 40 is brazed to the tube-and-fin assemblies 24, the outlet diffuser is brazed to the tube-and fin assemblies, and the end cap 30 is brazed to the tube-and-fin assemblies to form a core assembly 22. The core assembly 22 is received by the adaptors 66, 68 of the end cap 32 as the core assembly is mounted and sealed within the housing assembly 20. The side members 26, 28 are attached to the end caps 30, 32.

It is possible that the EGR cooler 10, including the housing assembly 20 and the core assembly 22, are formed of corrosion resistant alloys that help protect the EGR cooler from the corrosive exhaust gases.

What is claimed is:

1) An EGR cooler for a vehicle, the EGR cooler comprising:
a single housing assembly having an inlet and an outlet in fluid communication with an exhaust manifold and an intake manifold of an engine;
a single core assembly disposed within the housing assembly and having at least one tube-and-fin assembly for communicating exhaust gas from the inlet to the outlet;
a collar disposed around the core assembly and attached to the housing assembly to form a first temperature radiator having a first cooling volume and a second temperature radiator having a second cooling volume, the core assembly at least partially extending into the first cooling volume and the second cooling volume;
a first radiator inlet and a first radiator outlet in the first temperature radiator for communicating cooling fluid having a first temperature; and
a second radiator inlet and a second radiator outlet for communicating cooling fluid having a second temperature lower than the first temperature.

2) The EGR cooler of claim 1 wherein the core assembly extends substantially the length of the housing assembly.

3) The EGR cooler of claim 1 wherein the housing assembly is generally elongate and rectangular in transverse cross-section.

4) The EGR cooler of claim 1 further comprising an entrance diffuser in fluid communication and upstream of the core assembly.

5) The EGR cooler of claim 1 further comprising an outlet diffuser in fluid communication and downstream of the core assembly.

6) The EGR cooler of claim 1 wherein the collar is sealingly attached to the core assembly.

7) The EGR cooler of claim 1 wherein the collar is brazed to the core assembly.

8) The EGR cooler of claim 1 wherein the collar is sealingly attached to the housing assembly.

9) The EGR cooler of claim 1 wherein the housing assembly has first and second side members that are generally parallel with the core assembly.

10) A method of cooling exhaust gas from an engine in an EGR cooler for recirculation to the engine, the method comprising the steps of:
transporting the exhaust gas from the engine to a core assembly disposed inside a single housing assembly;
dividing the housing assembly into at least a first cooling volume of the EGR cooler and a second cooling volume of the EGR cooler, wherein the core assembly extends at least partially into the first cooling volume and the second cooling volume;
introducing a first cooling fluid into the first cooling volume;
introducing a second cooling fluid into the second cooling volume; and
transporting the exhaust gas from the core assembly to the engine.

11) The method of claim 10 further comprising the step of introducing the first cooling fluid at a first temperature, and introducing the second cooling fluid at a second temperature, wherein the first temperature is higher than the second temperature.

12) The method of claim 10 further comprising the step of transporting the exhaust gas through a plurality of tube-and-fin assemblies in the core assembly.

13) The method of claim 10 further comprising the step of sealing the first cooling volume from the second cooling volume.

14) An EGR cooler for a vehicle, the EGR cooler comprising:
a housing assembly having at least one side member, a first end cap having an inlet, and a second end cap having an outlet, wherein the inlet and the outlet are in fluid communication with an exhaust manifold and an intake manifold of an engine;
a core assembly extending substantially the length of the housing assembly and disposed within the housing assembly, the core assembly having at least one tube-and-fin assembly extending substantially from the inlet to the outlet;
a collar sealingly disposed around the core assembly and sealingly attached to the housing to form a first cooling volume and a second cooling volume;
a first radiator inlet and a first radiator outlet disposed in the at least one side member and in fluid communication with the first cooling volume for communicating cooling fluid having a first temperature; and
a second radiator inlet and a second radiator outlet disposed in the at least one side member and in fluid communication with the second cooling volume for communicating cooling fluid having a second temperature.

15) The EGR cooler of claim 14 wherein the core assembly does not contact the at least one side member of the housing assembly.

16) The EGR cooler of claim 14 wherein the housing assembly is generally elongate and rectangular in transverse cross-section.

17) The EGR cooler of claim 14 further comprising an entrance diffuser in fluid communication and upstream of the core assembly.

18) The EGR cooler of claim 14 wherein the collar is brazed to the core assembly.

19) The EGR cooler of claim 14 wherein the first temperature of cooling fluid is higher than the second temperature of cooling fluid.

20) The EGR cooler of claim 14 wherein the collar is attached to an interior surface of the housing assembly with a seal mount having a mount member attached to the at least one side member, and a seal located between the mount member and an extension portion of the collar.
